(19) United States
(12) Patent Application Publication
(10) Pub. No.: US 2015/0146142 A1
(43) Pub. Date: May 28, 2015

(54) OPTICAL COMPENSATION FILM FOR LIQUID CRYSTAL DISPLAY AND LIQUID CRYSTAL DISPLAY INCLUDING THE SAME

(71) Applicant: SHENZHEN CHINA STAR OPTOELECTRONICS TECHNOLOGY CO., LTD., Shenzhen, Guangdong (CN)

(72) Inventors: Chih-Tsung Kang, Shenzhen (CN); Bo Hai, Shenzhen (CN)

(21) Appl. No.: 14/241,831

(22) PCT Filed: Jan. 21, 2014
(86) PCT No.: PCT/CN2014/071017

§ 371 Date: Feb. 27, 2014

(30) Foreign Application Priority Data
Nov. 22, 2013 (CN) 201310596623.5

(51) Int. Cl. G02F 1/13363; G02F 1/1335

(52) U.S. Cl. CPC G02F 1/133634; G02F 1/133528; G02F 1/13363; G02F 2001/133531
USPC 349/102; 349/119; 349/118

(57) ABSTRACT

The present invention relates to liquid crystal display technology, and provides an optical compensation film for a liquid crystal display, including a first polarizer and a second polarizer disposed on both sides of the liquid crystal panel respectively, and an A-plate and a C-plate arranged between the liquid crystal panel and the first polarizer or between the liquid crystal panel and the second polarizer, wherein the in-plane compensation value for optical path difference of the A-plate Ro_{A-plate} lies in the range of [92, 184]nm, the compensation value for optical path difference in the thickness direction of the A-plate Rth_{A-plate} lies in the range of [46, 92]nm. The dark-state light leakage distribution and the contrast ratio of the display are improved through the optical compensation film according to the invention. The invention further provides a liquid crystal display including an optical compensation film.

### FIELD OF THE INVENTION

The present disclosure relates to the technical field of liquid crystal display, and particularly, relates to an optical compensation film for a liquid crystal display and the liquid crystal display including the same.

### BACKGROUND OF THE INVENTION

The contrast ratio of a liquid crystal display, directly related with its adaptability, significantly affects how it would be accepted by the market. The contrast ratio is a ratio of the luminance of the brightest color (white) to that of the darkest color (black) of the display. Generally, the insufficient dark state is a main factor limiting the contrast ratio of the liquid crystal display. With the increase of a viewing angle of a thin film transistor-liquid crystal display (TFT-LCD), the contrast ratio of pictures is continually reduced, and the sharpness of the pictures also correspondingly declines. This is due to the fact that the birefringence of liquid crystal molecules in a liquid crystal layer is changed along with the viewing angle. With a compensation achieved by adopting a wide-view compensation film, light leakage of dark-state pictures can be effectively reduced, and the contrast ratio of the pictures can be greatly improved within a certain viewing angle. Generally, the compensation film functions based on the principle that it offsets the phase difference generated by a liquid crystal under different viewing angles, so as to symmetrically compensate the birefringence performance of the liquid crystal molecules.

The compensation film adopted should be differentiated regarding different liquid crystal display modes, and the compensation film used in a large-sized liquid crystal television mostly aims at a vertical alignment (VA) display mode.

As the compensation value of the compensation film varies, the status of dark-state light leakage under a large viewing angle also varies, and thus the contrast ratio differs within the same length of optical path difference (LCΔNd) of a liquid crystal.

For example, FIG. 1 shows a corresponding diagram of dark-state light leakage distribution in the prior art when the optical path difference in liquid crystal (LCΔNd) is 315 nm, and FIG. 2 shows a diagram of full-view contrast ratio distribution. In FIG. 1 and FIG. 2, the optical path differences in liquid crystal, the pre-tilt angles of the liquid crystal and the compensation values of an A-plate (positive double-zigzag uniaxial film) and a C-plate (negative double-zigzag uniaxial film) are shown in Table 1.

TABLE 1

| | | | compensation | compensation |
|---|---|---|---|---|
| | | in-plane | value Rₜₕ for | value Rₜₕ for |
| optical | | compensation | optical path | optical path |
| path | pre-tilt | value Rₒ for | difference in | difference in |
| difference | angle of | optical path | the thickness | the thickness |
| in liquid | liquid | difference of | direction of | direction of |
| crystal | crystal | A-plate | A-plate | C-plate |
| 315 nm | 89 degrees | 109 nm | 55 nm | 403 nm |

Thus it could be seen that when A-plate and C-plate compensation values in the prior art are adopted, a serious light leakage would occur when viewing is taken in a dark state under a large angle. Therefore, the contrast ratio is lowered, and the range of the viewing angle is reduced. As a result, the sharpness of images would be greatly affected under some viewing angles.

### SUMMARY OF THE INVENTION

Aiming at improving the effect for reducing light leakage using a compensation film on a liquid crystal display, the present disclosure proposes an optical compensation film for a liquid crystal display, for reducing light leakage and increasing contrast.

Through research, inventors find that the compensation values of a C-plate and an A-plate in the compensation film are directly related to the effect for reducing light leakage by the compensation film, wherein a better effect for reducing light leakage can be obtained though the in-plane compensation value (Ro_{A-plate}) for optical path difference of the A-plate, the compensation value for optical path difference in the thickness direction (Rth_{A-plate}) of the A-plate and the compensation value for optical path difference in the thickness direction (Rth_{C-plate}) of the C-plate in the compensation film in respective specific ranges and in cooperation with one another.

Accordingly, the present disclosure proposes an optical compensation film for a liquid crystal display. In embodiment 1, the compensation film includes a first polarizer and a second polarizer disposed on both sides of the liquid crystal panel respectively, and a C-plate and an A-plate arranged between the liquid crystal panel and the first polarizer or between the liquid crystal panel and the second polarizer,

wherein the in-plane compensation value for optical path difference of the A-plate Ro_{A-plate} lies in the range of 92 nm≦Ro_{A-plate}≦184 nm,

the compensation value for optical path difference in the thickness direction of the A-plate Rth_{A-plate} lies in the range of 46 nm≦Rth_{A-plate}≦92 nm, and

the compensation value for optical path difference in the thickness direction of the C-plate Rth_{C-plate} lies in a range of Y₁ nm≦Rth_{C-plate}≦Y₂ nm, wherein Y₁=−0.000265x³+0.1272x²−13.8934x+604.55. Y₂=−0.0000789x⁴+0.021543x³−2.2088x²+100.7666x−1451, and x is the compensation value for optical path difference in the thickness direction of the A-plate Rth_{A-plate}.

In the context, an A-plate represents a positive double-zigzag uniaxial film, and a C-plate represents a negative double-zigzag uniaxial film.

According to embodiment 1, the light leakage in dark status which may occur in the prior art can be effectively reduced without impairing the transmittance of the liquid crystal panel, resulting in an increase of the contrast ratio and sharpness of the images under a large viewing angle, which is not in the horizontal or vertical azimuth.

In embodiment 2 improved according to embodiment 1, the C-plate is arranged on the same side of the liquid crystal panel as the A-plate, with the C-plate being closer to the liquid crystal panel.

In embodiment 3 improved according to embodiment 1 or 2, the C-plate is arranged on a different side of the liquid crystal panel from the A-plate.

In embodiment 4 improved according to any of embodiments 1 to 3, the slow axes of the C-plate and the A-plate are vertical to the absorption axis of the first polarizer or the second polarizer, which is on the same side of the liquid crystal panel as the respective A-plate or C-plate.

In embodiment 5 improved according to embodiment 2, the absorption axis of the first polarizer is 0 degree, the slow axis of the C-plate is 90 degrees, the slow axis of the A-plate is 90 degrees, and the absorption axis of the second polarizer is 90 degrees.

In embodiment 6 improved according to embodiment 3, the absorption axis of the first polarizer is 90 degrees, the slow axis of the C-plate is 0 degree, the slow axis of the A-plate is 90 degrees, and the absorption axis of the second polarizer is 0 degree.

While the structures of embodiments 5 and 6 are actually equivalent in terms of optical properties, other structures can also be applied to the compensation film according to the present invention without departing from the purpose of the invention.

In embodiment 7 improved according to any of embodiments 1 to 6, the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:

Ro=(Nₓ−N_{y})*d

Rth=[(Nₓ+N_{y})/2N_{z}]*d′

wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

The present disclosure further proposes a liquid crystal display including the above-mentioned optical compensation film, wherein the optical compensation film includes:

a first polarizer and a second polarizer disposed on both sides of the liquid crystal panel respectively, and a C-plate and an A-plate arranged between the liquid crystal panel and the first polarizer or between the liquid crystal panel and the second polarizer,

wherein the in-plane compensation value for optical path difference of the A-plate Ro_{A-plate} lies in the range of 92 nm≦Ro_{A-plate}≦184 nm,

the compensation value for optical path difference in the thickness direction of the A-plate Rth_{A-plate} lies in the range of 46 nm≦Rth_{A-plate}≦92 nm, and

the compensation value for optical path difference in the thickness direction of the C-plate Rth_{C-plate} lies in a range of Y₁ nm≦Rth_{C-plate}≦Y₂ nm, wherein Y₁=−0.000265x³+0.1272x²−13.8934x+604.55. Y₂=−0.0000789x⁴+0.021543x³−2.2088x²+100.7666x−1451, and x is the compensation value for optical path difference in the thickness direction of the A-plate Rth_{A-plate}.

In an embodiment of the display, the slow axes of the C-plate and the A-plate are vertical to the absorption axis of the first polarizer or the second polarizer, which is on the same side of the liquid crystal panel as the respective A-plate or C-plate.

In a further embodiment of the display, the optical path difference LCΔNd in liquid crystal of the liquid crystal panel lies in the range of 305.8 nm≦LCΔNd≦324.3 nm, and the pre-tilt angle of the liquid crystal of the liquid crystal panel lies in the range of 85°≦the pre-tilt angle≦89°.

Experiments shows that the light leakage distribution can be greatly reduced, so that the present disclosure has significant advantages compared with the prior art as long as the A-plate and the C-plates are within the compensation value ranges in the technical solutions of the present disclosure. The experiments will be discussed in detail with reference to the accompanying drawings below. Meanwhile, the contrast ratio can be increased and the range of viewing angle can be significantly broadened, with clear images to be received under large viewing angles.

The above-mentioned technical features may be combined in various appropriate manners or substituted by equivalent technical features, as long as the objective of the present disclosure can be fulfilled.

### BRIEF DESCRIPTION OF THE DRAWINGS

The present disclosure will be described in more detail below based on merely nonfinite examples with reference to the accompanying drawings. Wherein:

FIG. 1 shows a diagram of dark-state light leakage distribution with the A-plate and C-plate adopting the compensation values in the prior art mentioned in the background of the invention;

FIG. 2 shows a diagram for full-view contrast distribution with the A-plate and C-plate adopting the compensation values in the prior art mentioned in the background of the invention;

FIG. 3 schematically shows structure of an optical compensation film for a liquid crystal display according to the present disclosure;

FIG. 4 shows a trend of a maximum amount of dark-state light leakage as a function of the compensation values under different pre-tilt angles when the optical path difference in liquid crystal is 305.8 nm;

FIG. 5 shows a trend of a maximum amount of dark-state light leakage as a function of the compensation values under different pre-tilt angles when the optical path difference in liquid crystal is 324.3 nm;

FIG. 6 shows a diagram for dark-state full-view light leakage distribution in a first example of the present disclosure;

FIG. 7 shows a diagram for full-view contrast distribution in the first example of the present disclosure;

FIG. 8 shows a diagram for dark-state full-view light leakage distribution in a second example of the present disclosure;

FIG. 9 shows a diagram for full-view contrast distribution in the second example of the present disclosure;

FIG. 10 shows a diagram for dark-state full-view light leakage distribution in a third example of the present disclosure; and

FIG. 11 shows a diagram for full-view contrast distribution in the third example of the present disclosure.

In the drawings, the same components are indicated by the same reference signs. The accompanying drawings are not drawn in an actual scale.

### DETAILED DESCRIPTION OF THE EMBODIMENTS

The present disclosure will be introduced in detail below with reference to the accompanying drawings.

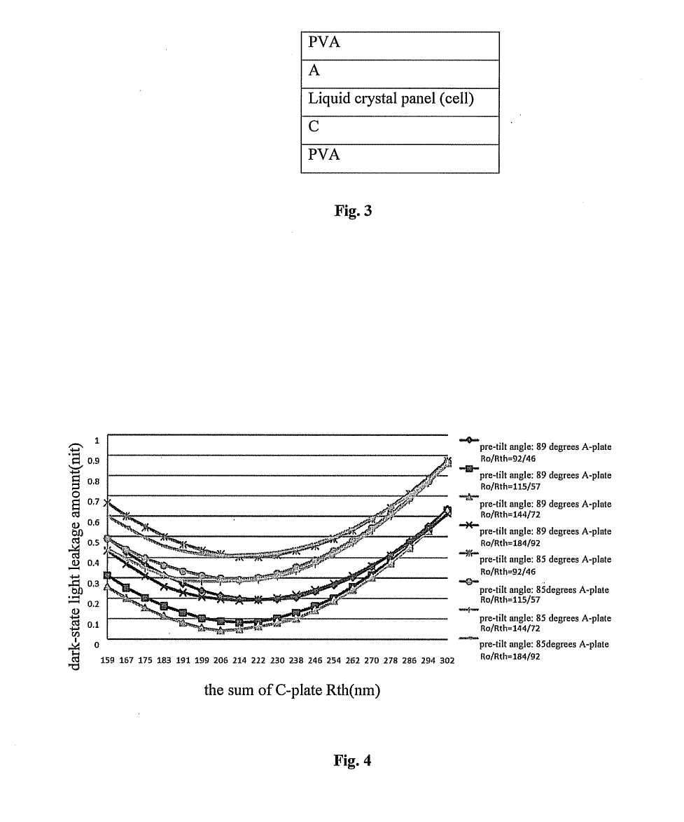

With reference to FIG. 3, an optical compensation film for a liquid crystal display according to the present disclosure includes a first polarizer, e.g. a polyvinyl alcohol layer, and a second polarizer, e.g. a polyvinyl alcohol layer, disposed on both sides of the liquid crystal panel respectively, and an A-plate and a C-plate arranged between the liquid crystal panel and the first polyvinyl alcohol layer or between the liquid crystal panel and the second polyvinyl alcohol layer.

In an optical compensation film according to the present disclosure, the absorption axis of an upper polarizer is 0 degree, and the absorption axis of a lower polarizer is 90 degrees. However, when the absorption axis of the upper polarizer is 90 degrees and the absorption axis of the lower polarizer is 0 degree, the solution of the present disclosure is still applicable if only the slow axes of the A-plate and the C-plate of the compensation structure are vertical to the absorption axis of the polyvinyl alcohol (PVA) layer which is on the same side of the liquid crystal panel (cell) as the respective A-plate or C-plate.

The optical compensation film according to the present disclosure may adopt one of the following four structures.

| | angle |
|---|---|
| Compensation structure 1 | |
| PVA(the upper polarizer) | absorption axis being 0 degree |
| C | slow axis being 90 degrees |
| liquid crystal panel (Cell) | |
| A | slow axis being 0 degree |
| PVA(the lower polarizer) | absorption axis being 90 degrees |
| Compensation structure 2 | |
| PVA(the upper polarizer) | absorption axis being 0 degree |
| A | slow axis being 90 degrees |
| liquid crystal panel (Cell) | |
| C | slow axis being 0 degree |
| PVA(the lower polarizer) | absorption axis being 90 degrees |
| Compensation structure 3 | |
| PVA(the upper polarizer) | absorption axis being 0 degree |
| A | slow axis being 90 degrees |
| C | slow axis being 90 degrees |
| liquid crystal panel (Cell) | |
| PVA(the lower polarizer) | absorption axis being 90 degrees |
| Compensation structure 4 | |
| PVA(the upper polarizer) | absorption axis being 0 degree |
| liquid crystal panel (Cell) | |
| C | slow axis being 0 degree |
| A | slow axis being 0 degree |
| PVA(the lower polarizer) | absorption axis being 90 degrees |

The above-mentioned angle could be the angle of the respective axis relative to a preset plane.

In an optical compensation film according to the present disclosure, the absorption axis of an upper polarizer is 0 degree, and the absorption axis of a lower polarizer is 90 degrees. However, when the absorption axis of the upper polarizer is 90 degrees and the absorption axis of the lower polarizer is 0 degree, the solution of the present disclosure is still applicable if only the slow axes of the A-plate and the C-plate of the compensation structure are vertical to the absorption axis of the polyvinyl alcohol (PVA) layer which is on the same side of the liquid crystal panel (cell) as the respective A-plate or C-plate.

The inventors discover that the compensation structures 1 to 4 are equivalent to each other during simulation. Namely, with the same compensation value, the maximum dark-state light leakage corresponding to each of the compensation structures 1 to 4 is the same.

Aiming at the above compensation structures, the inventors discover that the compensation values (in-plane compensation value for optical path difference and compensation value for optical path difference in the thickness direction) of the A-plate and the C-plate are related with the effect for reducing dark-state light leakage by the optical compensation film. For this reason, different compensation values of the A-plate and the C-plate can be used together to simulate the dark-state light leakage, and thus an optimal compensation value range can be found for corresponding dark-state light leakage within the tolerance.

The simulation adopts the following settings.

For the optical compensation film, the structure of the set optical compensation film for the liquid crystal display is shown in FIG. 3. Specifically, the film includes a first polyvinyl alcohol layer and a second polyvinyl alcohol layer disposed on both sides of the liquid crystal panel respectively, and an A-plate and a C-plate arranged between the liquid crystal panel and the first polyvinyl alcohol layer or between the liquid crystal panel and the second polyvinyl alcohol layer.

The slow axes of the A-plate and the C-plate are vertical to the absorption axis of the first polyvinyl alcohol layer or the second polyvinyl alcohol layer on the same side of the liquid crystal panel (cell) as the A-plate or the C-plate respectively.

For the liquid crystal, the pre-tilt angle lies in the range of 85°≦the pre-tilt angle<90° (four-domain liquid crystal tilt angles are 45°), and the optical path difference in liquid crystal LCΔNd lies in the range of 305.8 nm≦LCΔNd≦324.3 nm.

For the light source, blue light excited yttrium aluminum garnet fluorescent powder (Blue-YAG) LED spectra are used with the center brightness set as 100 nits, and Lambert's distribution is adopted for light source distribution.

With the above-mentioned settings, the dark-state light leakage condition is simulated for using different compensation values of the A-plate and the C-plates together.

The optical path difference in liquid crystal is selected as 305.8 nm and 324.3 nm, and the pre-tilt angle of the liquid crystal is selected as 85° and 89° respectively.

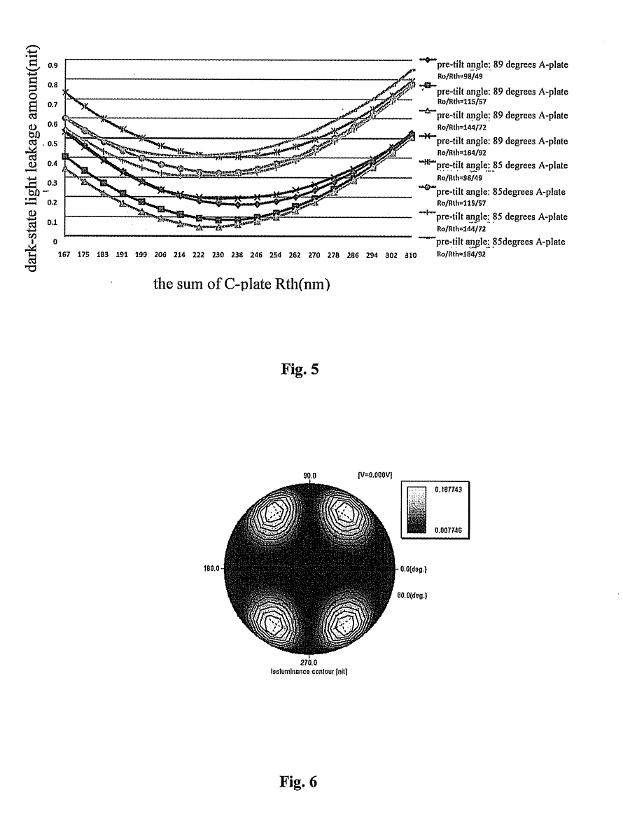

FIG. 4 shows a trend of a maximum amount of dark-state light leakage as a function of the compensation values under different pre-tilt angles when the optical path difference in liquid crystal is 305.8 nm. FIG. 5 shows a trend of a maximum amount of dark-state light leakage as a function of the compensation values under different pre-tilt angles when the optical path difference in liquid crystal is 324.3 nm.

In FIG. 4 and FIG. 5, different compensation values of A-plate and C-plate are used together for simulation with varied optical path differences in liquid crystal and pre-tilt angles respectively. It could be seen that the influence of the compensation values of A-plate and C-plate on dark-state light leakage tends to be consistent under different pre-tilt angles. Namely, the corresponding compensation value ranges within which the dark-state light leakage can be minimized are identical under different pre-tilt angles.

Thus, the optimal ranges of A-plate and C-plate compensation values in the optical compensation film can be obtained (shown in Table 2) when the optical path difference in liquid crystal LCΔNd lies in the range of 305.8 nm≦LCΔNd≦324.3 nm with the pre-tilt angle in the range of 85°≦the pre-tilt angle<90° (the pre-tilt angle adopted includes 89°) and the dark-state light leakage below 0.2 nit.

TABLE 2

| | in-plane compensation value | compensation value (nm) for | compensation value (nm) for |
|---|---|---|---|
| optical path | (nm) for the optical path | the optical path difference in | the optical path difference in |
| difference (nm) | difference of A-plate | the thickness direction of | the thickness direction of |
| in liquid crystal | Ro_{A-plate} | A-plate Rth_{A-plate} | C-plate Rth_{C-plate} |
| 305.8 nm ≦ | 92 nm ≦ | 46 nm ≦ | Y₁ nm ≦ |
| LCΔNd ≦ | Ro_{A-plate} ≦ | Rth_{A-plate} ≦ | Rth_{C-plate} ≦ |
| 324.3 nm | 184 nm | 92 nm | Y₂ nm |

Wherein, Y₁=−0.000265x³+0.1272x²−13.8934x+604.55, and Y₂=−0.0000789x⁴+0.021543x³−2.2088x²+100.7666x−1451, and x is the compensation value for optical path difference in the thickness direction of the A-plate Rth_{A-plate}.

Namely, when the optical path difference in liquid crystal LCΔNd lies in the range of 305.8 nm≦LCΔNd≦324.3 nm and the pre-tilt angle lies in the range of 85°≦the pre-tilt angle<90°, the ideal dark-state light leakage reducing effect may be achieved by compatibly using the compensation values of the A-plate and the C-plates of different optical compensation film structures. The range of optimal compensation values is mentioned above, as shown in Table 2.

Once the appropriate range for compensation value is found and the in-plane compensation value for optical path difference (Rₒ) is known, the relationship among the compensation value for optical path difference (Rₜₕ) in the thickness direction, the refractive index N and the thickness d can be determined as follows:

Ro=(Nₓ−N_{y})*d

Rth=[(Nₓ+N_{y})/2−N_{z}]*d

wherein x and y represent in-plane directions, and z represents the thickness direction.

Thus, the compensation values may be adjusted with the following three methods.

Method a): The refractive indexes N of the conventional A-plate and C-plates stay unchanged, while the compensation values are adjusted by changing the thickness d.

Method b): Based on the conventional A-plate and C-plates, the compensation values are adjusted by changing the refractive indexes N.

Method c): The compensation values are adjusted by changing the thickness d and the refractive indexes N at the same time, while the compensation values of the A-plate and the C-plates are maintained within the ranges.

In other words, the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:

Ro=(Nₓ−N_{y})*d

Rth=[(Nₓ+N_{y})/2−N_{z}]*d′

wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

Corresponding to the optical compensation film proposed in the present disclosure, three examples as following are provided for comparison with the example in prior art as mentioned in the background portion.

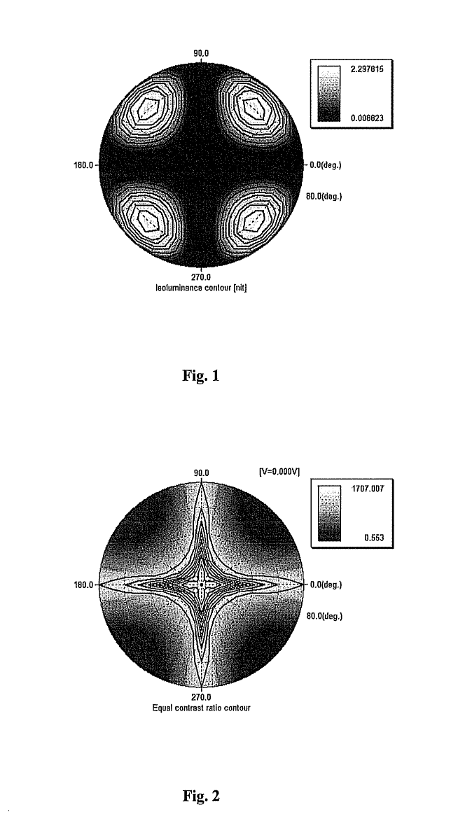

For comparison with the effects of the optical compensation film in the prior art shown in FIG. 1 and FIG. 2, dark-state light leakage and full-view contrast distribution are compared with changing the compensation values of the A-plate and the C-plates in the optical compensation film according to the present disclosure.

3 groups of in-plane compensation values for optical path difference Ro and compensation values Rth for optical path difference in the thickness direction of the A-plate and the C-plates are selected.

### Example 1

| optical path | pre-tilt | | | |
|---|---|---|---|---|
| difference | angle of | | | |
| in liquid | liquid | A-plate | A-plate | the sum of |
| crystal | crystal | Ro | Rth | C-plate Rth |
| 333.5 nm | 89 degrees | 132 nm | 66 nm | 179 nm |

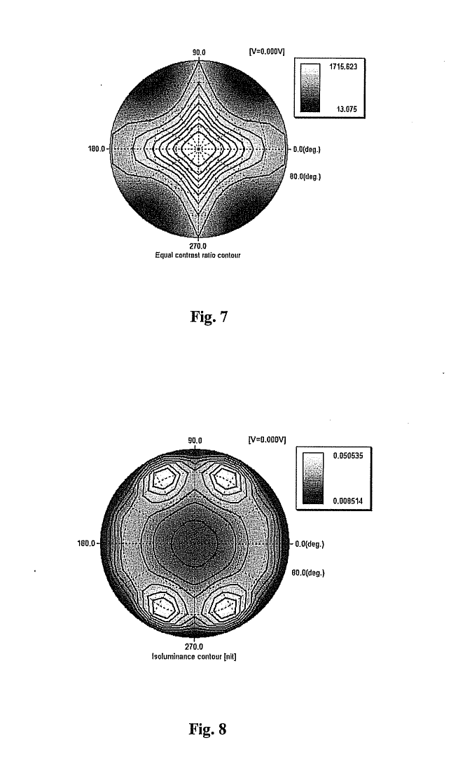

FIG. 6 shows a diagram of dark-state full-view light leakage distribution in Example 1, and FIG. 7 shows a diagram of full-view contrast distribution in Example 1.

### Example 2

| optical path | pre-tilt | | | |
|---|---|---|---|---|
| difference | angle of | | | |
| in liquid | the liquid | A-plate | A-plate | the sum of |
| crystal | crystal | Ro | Rth | C-plate Rth |
| 333.5 nm | 89 degrees | 132 nm | 66 nm | 206 nm |

FIG. 8 shows a diagram of dark-state full-view light leakage distribution in Example 2, and FIG. 9 shows a diagram of full-view contrast distribution in Example 2.

### Example 3

| optical path | pre-tilt | | | |
|---|---|---|---|---|
| difference | angle of | | | |
| in liquid | the liquid | A-plate | A-plate | the sum of |
| crystal | crystal | Rₒ | Rₜₕ | C-plate Rₜₕ |
| 333.5 nm | 89 degrees | 132 nm | 66 nm | 266 nm |

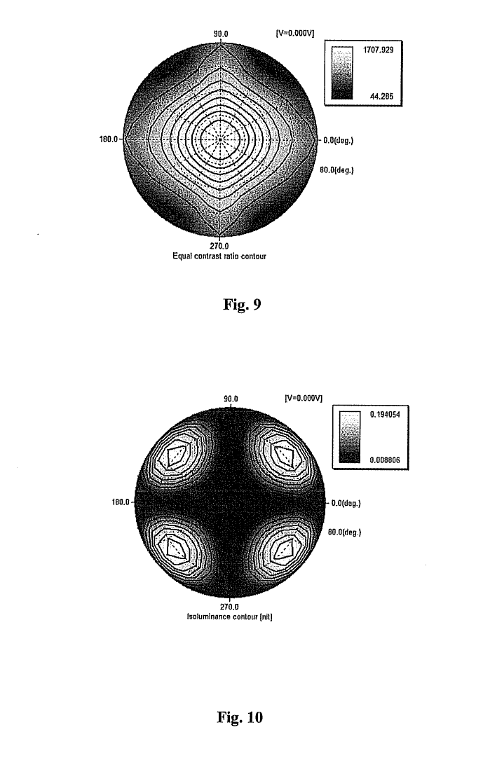

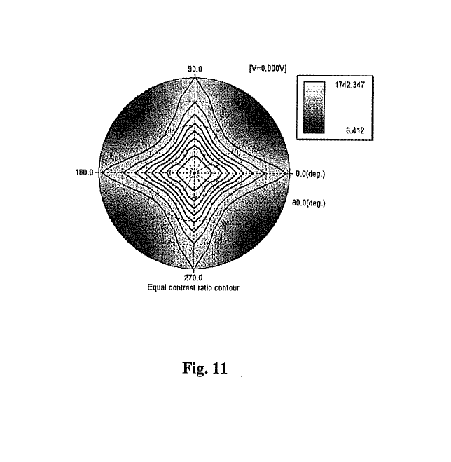

FIG. 10 shows a diagram of dark-state full-view light leakage distribution in Example 3, and FIG. 11 shows a diagram of full-view contrast distribution in Example 3.

In FIG. 6 to FIG. 11:

| | maximum | minimum | | |
|---|---|---|---|---|
| | light | light | maximum | minimum |
| | leakage (nit) | leakage (nit) | contrast | contrast |
| Comparative | 2.297815 | 0.008823 | 1707.007 | 0.553 |
| example | | | | |
| Example 1: | 0.187743 | 0.007746 | 1715.623 | 13.075 |
| Example 2 | 0.050535 | 0.008514 | 1707.929 | 44.285 |
| Example 3 | 0.194054 | 0.008806 | 1742.347 | 6.412 |

By comparing FIG. 6, FIG. 8 and FIG. 10 corresponding to Example 1, Example 2 and Example 3 respectively with FIG. 1, it could be found that after the compensation values of the A-plate and the C-plates of the optical compensation film are adjusted, the maximum dark-state light leakage is reduced from 2.3 nits to 0.2 nit or below, which is far lower than the dark-state light leakage obtained with the optical compensation film in the prior art.

By comparing FIG. 7, FIG. 9 and FIG. 11 corresponding to Example 1, Example 2 and Example 3 respectively with FIG. 2, it could be found that after the compensation values of the A-plate and the C-plates of the optical compensation film are adjusted, the full-view contrast distribution is far better than that obtained with the optical compensation film in the prior art.

The present disclosure also proposes a liquid crystal display including the above-mentioned optical compensation film.

Although the present disclosure has been described with reference to the preferred examples, various modifications could be made to the present disclosure without departing from the scope of the present disclosure and components in the present disclosure could be substituted by equivalents. The present disclosure is not limited to the specific examples disclosed in the description, but includes all technical solutions falling into the scope of the claims.

1. An optical compensation film for a liquid crystal display, including:
a first polarizer and a second polarizer disposed on both sides of the liquid crystal panel respectively, and an A-plate and a C-plate arranged between the liquid crystal panel and the first polarizer or between the liquid crystal panel and the second polarizer,
wherein the in-plane compensation value for optical path difference of the A-plate Ro_{A-plate} lies in the range of 92 nm≦Ro_{A-plate}≦184 nm,
the compensation value for optical path difference in the thickness direction of the A-plate Rth_{A-plate} lies in the range of 46 nm≦Rth_{A-plate}≦92 nm, and
the compensation value for optical path difference in the thickness direction of the C-plate Rth_{C-plate} lies in a range of Y₁ nm≦Rth_{C-plate}≦Y₂ nm, wherein Y₁=−0.000265x³+0.1272x²−13.8934x+604.55, Y₂=−0.0000789x⁴+0.021543x³−2.2088x²+100.7666x−1451, and x is the compensation value for optical path difference in the thickness direction of the A-plate Rth_{A-plate}.

2. The optical compensation film according to claim 1, wherein the C-plate is arranged on the same side of the liquid crystal panel as the A-plate, with the C-plate being closer to the liquid crystal panel.

3. The optical compensation film according to claim 1, wherein the C-plate is arranged on a different side of the liquid crystal panel from the A-plate.

4. The optical compensation film according to claim 1, wherein the slow axes of the C-plate and the A-plate are vertical to the absorption axis of the first polarizer or the second polarizer, which is on the same side of the liquid crystal panel as the respective A-plate or C-plate.

5. The optical compensation film according to claim 2, wherein the absorption axis of the first polarizer is 0 degree, the slow axis of the C-plate is 90 degrees, the slow axis of the A-plate is 90 degrees, and the absorption axis of the second polarizer is 90 degrees.

6. The optical compensation film according to claim 3, wherein the absorption axis of the first polarizer is 90 degrees, the slow axis of the C-plate is 0 degree, the slow axis of the A-plate is 90 degrees, and the absorption axis of the second polarizer is 0 degree.

7. The optical compensation film according to claim 1, wherein the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:
Ro=(Nₓ−N_{y})*d
Rth=[(Nₓ+N_{y})/2−N_{z}]*d′
wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

8. The optical compensation film according to claim 2, wherein the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:
Ro=(Nₓ−N_{y})*d
Rth=[(Nₓ+N_{y})/2−N_{z}]*d′
wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

9. The optical compensation film according to claim 3, wherein the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:
Ro=(Nₓ−N_{y})*d
Rth=[(Nₓ+N_{y})/2−N_{z}]*d′
wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

10. The optical compensation film according to claim 4, wherein the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} adjusted through changing the refractive index and/or the thickness of the C-plate, in accordance with the following equations:
Ro=(Nₓ−N_{y})*d
Rth=[(Nₓ+N_{y})/2−N_{z}]*d′
wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

11. The optical compensation film according to claim 5, wherein the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:
Ro=(Nₓ−N_{y})*d
Rth=[(Nₓ+N_{y})/2−N_{z}]*d
wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

12. The optical compensation film according to claim 6, wherein the in-plane compensation value for optical path difference of the A-plate Ro_{A-plate} and the compensation value for optical path difference in the thickness direction of the A-plate Rth_{A-plate} are both adjusted through changing the refractive index and/or the thickness of the A-plate, while the compensation value for optical path difference in the thickness direction of the C-plate Rth_{C-plate} is adjusted through changing the refractive index and/or the thickness of the C-plate, in accordance with the following equations:
Ro=(Nₓ−N_{y})*d
Rth=[(Nₓ+N_{y})/2−N_{z}]*d′
wherein Nₓ and N_{y} represent the refractive indexes of the respective A-plate or C-plate along in-plane directions, with x and y representing in-plane directions perpendicular to each other, N_{z} represents the refractive index in the thickness direction of the respective A-plate or C-plate, d represents the thickness of the respective A-plate or C-plate, and Ro and Rth represent the in-plane compensation value for optical path difference and the compensation value for optical path difference in the thickness direction of the respective A-plate or C-plate in each case.

13. A liquid crystal display including an optical compensation film, wherein the optical compensation film includes:
a first polarizer and a second polarizer disposed on both sides of the liquid crystal panel respectively, and an A-plate and a C-plate arranged between the liquid crystal panel and the first polarizer or between the liquid crystal panel and the second polarizer,
wherein the in-plane compensation value for optical path difference of the A-plate Ro_{A-plate} lies in the range of 92 nm≦Ro_{A-plate}≦184 nm,
the compensation value for optical path difference in the thickness direction of the A-plate Rth_{A-plate} lies in the range of 46 nm≦Rth_{A-plate}≦92 nm, and
the compensation value for optical path difference in the thickness direction of the C-plate Rth_{C-plate} lies in a range of Y₁ nm≦Rth_{C-plate}≦Y₂ nm, wherein Y₁=−0.000265x³+0.1272x²−13.8934x+604.55, Y₂=−0.0000789x⁴+0.021543x³−2.2088x²+100.7666x−1451, and x is the compensation value for optical path difference in the thickness direction of the A-plate Rth_{A-plate}.

14. The display according to claim 13, wherein the slow axes of the C-plate and the A-plate are vertical to the absorption axis of the first polarizer or the second polarizer, which is on the same side of the liquid crystal panel as the respective A-plate or C-plate.

15. The display according to claim 13, wherein the optical path difference LCΔNd in liquid crystal of the liquid crystal panel lies in the range of 305.8 nm≦LCΔNd≦324.3 nm, and the pre-tilt angle of the liquid crystal of the liquid crystal panel lies in the range of 85°≦the pre-tilt angle≦89°.

16. The display according to claim 14, wherein the optical path difference LCΔNd in liquid crystal of the liquid crystal panel lies in the range of 305.8 nm≦LCΔNd≦324.3 nm, and the pre-tilt angle of the liquid crystal of the liquid crystal panel lies in the range of 85°≦the pre-tilt angle≦89°.
